(19) United States
(12) Patent Application Publication
(10) Pub. No.: US 2024/0217325 A1
(43) Pub. Date: Jul. 4, 2024

(54) REMOVABLE PROTECTOR FOR VEHICLE BODY

(71) Applicant: Bumper Ninja Inc., New York, NY (US)

(72) Inventor: Patrick Alcindor, Brooklyn, NY (US)

(73) Assignee: Bumper Ninja Inc., New York, NY (US)

(21) Appl. No.: 18/091,012

(22) Filed: Dec. 29, 2022

(51) Int. Cl. B60J 11/06; B60R 13/04

(52) U.S. Cl. CPC B60J 11/06; B60R 13/04; B62D 65/16

(57) ABSTRACT

A vehicle body protector comprises a panel assembly and a theft-protection device. The panel assembly comprises a padding member on a first side and a housing on a second side. At least one magnet is positioned within the housing. The theft-protection device comprises a cable having a first end and an opposing second end. The cable first end is operably coupled to the panel assembly. The theft-protection device also comprises a locking assembly. The cable second end is operably coupled to the locking assembly. The panel assembly is magnetically attached to a body of a vehicle and further secured to the vehicle with the locking assembly.

### FIELD

The present invention relates to devices for protecting vehicles bodies from damage and more specifically to a removable protector for vehicle bodies.

### BACKGROUND

It is a frequent occurrence that a vehicle, especially when parked too close to other vehicles in a parking lot, is subject to being damaged by the doors of vehicles in adjacent parking spots or passerby walking next to the vehicle. The occupants of adjacent vehicles and passerby may be unaware that their vehicle doors, their shopping carts, or they themselves are causing the other vehicle to be scratched, dinged, dented, or otherwise damaged.

Vehicles equipped with body side molding may have some protection, but many cars are sold with no such molding. Further, most body side moldings are merely decorative and unable to provide any protection at all.

Several attempts have been made in the past to provide a protective door guard apparatus or similar removable structure for parked vehicles. However, several drawbacks are associated with the existing door guards. For example, those door guards are often cumbersome to use, i.e., not easy to install and remove, expensive to manufacture, not adjustable for a variety of vehicles, or not theft-resistant. Moreover, those door guards are heavy and bulky, and require additional space for storage or are not easy to store.

Therefore, a need exists for a vehicle body protector that is lightweight, easy to attach onto or remove from the vehicle, inexpensive to manufacture, and easy to store.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention relates generally to the art of guards for protecting outer surfaces of motor vehicles from contact with hard objects, such as doors of other vehicles. More specifically, the present invention is a vehicle body protector or door guard which can be mounted on exterior surfaces of vehicles by magnets. The present invention is specifically designed for protecting the doors of vehicles. However, the present invention is not limited to this option, and it may further be adapted for different purposes, such as protecting the bumpers of vehicles.

As such, the present invention is a vehicle body protector designed to fully protect a desired area or areas from damage such as scratches, dings, and dents. The present invention can be removably attached to the sides of a vehicle. Moreover, the present invention comprises an anti-theft mechanism such that the door guard is resistant to unauthorized removal. The present invention further allows users to easily transport and store the vehicle body protector.

In one aspect, the present invention provides a vehicle body protector comprising: a flexible front panel comprising an inner section and an opposing outer section, the front panel having a plurality of corners and a midpoint positioned substantially equidistant from each corner, the inner section comprising: a plurality of first receptacles configured to receive a plurality of first magnets, each of the first magnets having an extension member extending therefrom, each first receptacle and first magnet being substantially circular, each first magnet housed within each first receptacle and positioned at each corner and the midpoint; and a plurality of second receptacles configured to receive a plurality of second magnets, each second receptacle and second magnet being substantially elongate, each second magnet housed within each second receptacle and positioned between each corner and midpoint, and the outer section comprising a padding member comprising a plurality of grooves; a flexible rear panel sized and shaped substantially the same as the front panel, wherein the inner section of the front panel and the rear panel are operably coupled together by frictional engagement; and a theft-protection device comprising a first magnet assembly, an opposing locking assembly and a cable therebetween, the first magnet assembly comprising: a lower member comprising a first aperture, the lower member positioned in one of the plurality of first receptacles; an insert having a second aperture, the insert operably coupled to the first aperture; and a first end of the cable, the cable first end operably coupled to the extension member of one of the plurality of first magnets, wherein the extension member of one of the plurality of first magnets is operably coupled to the second aperture of the insert while the cable first end is positioned between one of the plurality of first magnets and the lower member, and the locking assembly comprising: a body member and a locking member, the locking member being flexible and extending from the body member, wherein the locking assembly is operably coupled with a second end of the cable; wherein the rear panel is magnetically attached to a body of a vehicle; and wherein the locking member is inserted into a slot formed adjacent to an edge of a door of the vehicle, whereby the locking member abuts an interior of the door and is secured to the vehicle.

In another aspect, the present invention provides a vehicle body protector comprising: a front panel comprising an inner section and an opposing outer section, the front panel having a plurality of corners and a midpoint positioned substantially equidistant from each corner, the inner section comprising: a plurality of first receptacles configured to receive a plurality of first magnets, each first magnet housed within each first receptacle; and the outer section comprising a padding member; and a theft-protection device comprising a first magnet assembly, an opposing locking assembly and a cable therebetween, the first magnet assembly comprising: a lower member positioned in one of the plurality of first receptacles; an insert operably coupled to the lower member; and a first end of the cable, the cable first end operably coupled to one of the plurality of first magnets, wherein one of the plurality of first magnets is operably coupled to the insert while the cable first end is positioned between one of the plurality of first magnets and the lower member, and the locking assembly comprising a locking member, the locking member being flexible, wherein the locking assembly is operably coupled with a second end of the cable; wherein the front panel is magnetically attached to a body of a vehicle; and wherein the locking member is inserted into a slot formed adjacent to an edge of a door of the vehicle, whereby the locking member abuts an interior of the door and is secured to the vehicle.

In yet another aspect, the present invention provides a vehicle body protector comprising: a panel assembly having a first side and an opposing second side, the panel assembly comprising: a padding member on the first side; a housing on the second side; and at least one magnet positioned within the housing; and a theft-protection device comprising: a cable having a first end and an opposing second end, the cable first end operably coupled to the panel assembly; and an opposing locking assembly, the cable second end operably coupled to the locking assembly; wherein the panel assembly is magnetically attached to a body of a vehicle; and wherein the locking assembly is secured to the vehicle.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows an embodiment of a vehicle body protector of the present invention installed on a vehicle;

FIG. 2 shows the vehicle body protector of FIG. 1 uninstalled;

FIG. 3 shows the vehicle body protector of FIG. 1 with front and rear panels disassembled, specifically, a front view of the front panel and a rear view of the rear panel;

FIG. 4 shows the vehicle body protector of FIG. 1 with front and rear panels disassembled, specifically, a rear view of the front panel and a front view of the rear panel;

FIG. 5 shows a partially exploded view of another embodiment of a vehicle body protector of the present invention;

FIG. 6 is an exploded view of the front panel of FIG. 1;

FIG. 7 shows an exploded view of a magnet assembly of the vehicle body protector of the present invention;

FIG. 8 shows components of the magnet assembly of FIG. 7 partially assembled;

FIG. 9 shows components of the magnetic assembly of FIG. 7 assembled;

FIG. 10 shows a theft-protection device of the vehicle body protector of the present invention;

FIG. 11 shows a top perspective view of a locking assembly of the theft-protection device of FIG. 10;

FIG. 12 shows a bottom view of the locking assembly of FIG. 11;

FIG. 13 shows an initial step of installing the locking assembly of FIG. 11 to a vehicle; and

FIG. 14 shows the locking assembly of FIG. 11 installed on a vehicle.

To facilitate an understanding of the invention, identical reference numerals have been used, when appropriate, to designate the same or similar elements that are common to the figures. Further, unless stated otherwise, the features shown in the figures are not drawn to scale and are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

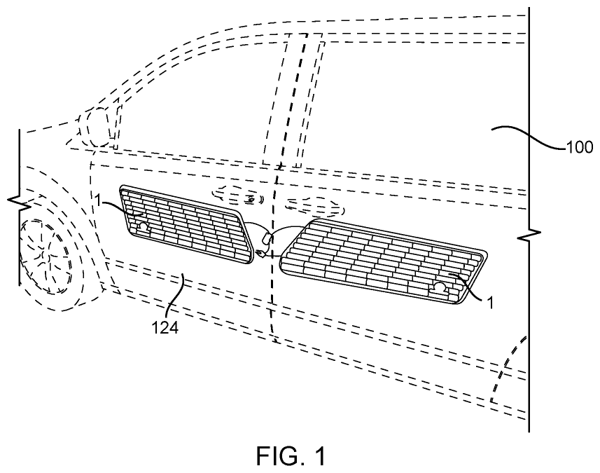

Referring to FIG. 1, an embodiment of a vehicle body protector 1 of the present invention is shown. In general the vehicle body protector 1 is magnetically attached to a body of a vehicle 100 at a desired location. For example, the vehicle body protector 1 could be attached to doors, front or rear panels, hoods and bumpers where the user wishes to protect the vehicle body from damage.

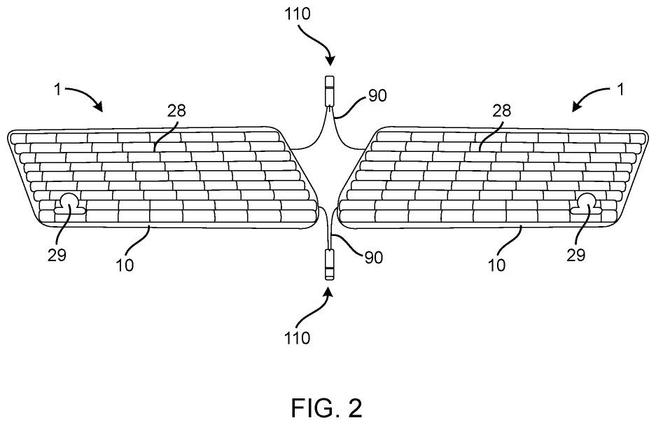

Referring to FIGS. 2-4, in this embodiment, the vehicle body protector 1 includes a flexible front panel 10 and a flexible rear panel 40. The front panel 10 includes an inner section 12 and an opposing outer section 14. In this embodiment, the front panel 10 is shaped as a parallelogram but the front panel 10 could take on other shapes such as rectangle, square or circle without departing from the spirit and scope of the invention. The front panel 10 includes four corners 16a, 16b, 16c, 16d and a midpoint 16e positioned substantially equidistant from each corner 16a-d.

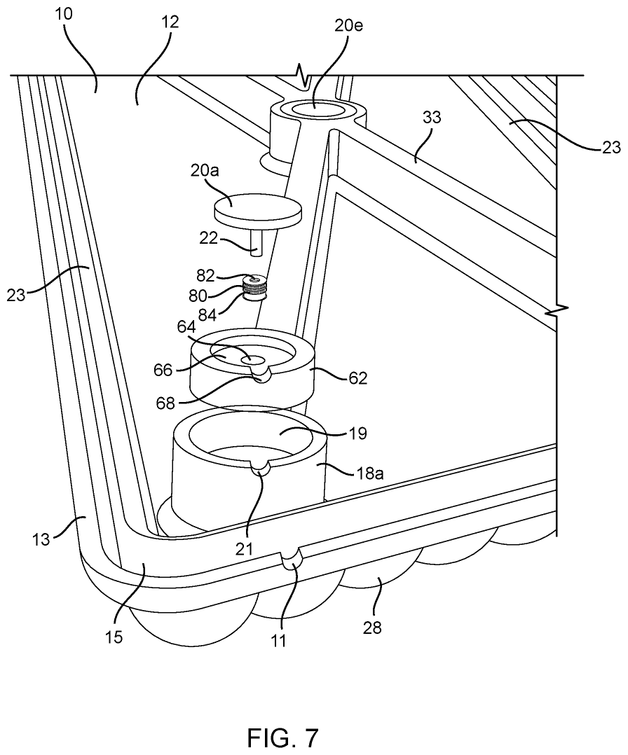

Still referring to FIGS. 2-4, the inner section 12 includes a lip 13 along the edges forming an upper surface 15 thereunder. An edge of the lip 13 includes openings 11 at or near the corners of the front panel 10, as shown in FIG. 7. Moreover, a lower surface 17 is formed below the upper surface 15 inward from the upper surface 15, with a wall 23 extending between the upper and lower surfaces 15, 17, as shown, for example, in FIG. 7. The lower surface 17 includes receptacles 18a, 18b, 18c, 18d, 18e configured to receive primary magnets 20a, 20b, 20c, 20d, 20e. As shown in FIG. 7, each primary magnet 20a-e includes a threaded extension member 22 extending therefrom and integrally formed thereto. In this embodiment, the extension member 22 is constructed of a durable metal but other materials such as plastic could be used. In this embodiment, each receptacle 18a-e and primary magnet 20a-e are substantially circular, however, one of ordinary skill in the art will recognize that the receptacles 18a-e and primary magnets 20a-e could take on other shapes such as square, triangle or oval. Each primary magnet 20a-e is housed within each receptacle 18a-e positioned at each corner 16a-d and the midpoint 16e. In this embodiment, the height of the receptacles 18a-e is substantially similar to the height between the distance between the lower surface 17 and the upper surface 15. The inner section 12 also includes hollow columns 33 extending between the corner receptacles 18a-d and the midpoint receptacle 18e, which are integrally formed with the receptacles 18a-e and inner section 12. The columns 33 provide structure and stability to the front panel 10 so that the vehicle body protector 1 maintains form.

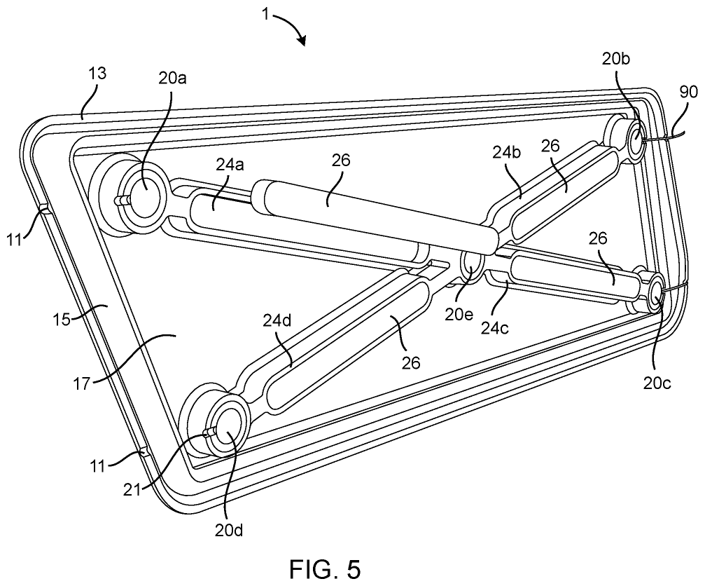

Referring to FIG. 5, in another embodiment, instead of columns 33, the front panel 10 includes additional receptacles 24a, 24b, 24c, 24d configured to receive secondary magnets 26a, 26b, 26c, 26d. That is, the receptacles 24a-d are sized and shaped substantially similar to the secondary magnets 26a-d so that each secondary magnet 26a-d is friction fit in a corresponding receptacle 24a-d. In other embodiments, the receptacles 24a-d could include an upper lip so that the secondary magnets 26a-d could be snap-fit therein. In this embodiment, each receptacle 24a-d and secondary magnet 26a-d are substantially elongate, i.e., has a length greater than a width, and each secondary magnet 26a-d is housed within each receptacle 24a-d, and positioned between each corner 16a-d and the midpoint 16e. As a result, in this embodiment, four secondary magnets 26a-d are provided. The elongate secondary magnets 26a-d provide additional magnetic force for attaching to the vehicle 100 to supplement the magnetic force provided by the smaller primary magnets 20a-e, to prevent the vehicle body protector 1 from moving or sliding on the vehicle body when installed. Alternatively, the front panel 10 could be provided with less than four secondary magnets and the secondary magnets could be positioned elsewhere, e.g., longitudinally extending along the length of the front panel 10 or transversely along the width of the front panel 10. In this embodiment, the secondary magnets 26a-d are flexible magnets such as extruded permanent magnets manufactured by bonding a strontium magnetic powder in a flexible vinyl binder. As such, the secondary magnets 26a-d are low-cost and light-weight, and further provide flexibility for attaching to different contours of vehicles bodies. However, in other embodiments, the secondary magnets 26a-d could be solid, non-flexible magnets so long as sufficient magnetic force is provided.

In the embodiments shown, the front panel 10, including the components of the inner and outer sections 12, 14 described above, is constructed of an injection-molded plastic having some flexibility and the ability to deform. However, other materials such as EVA foam could be formed to construct the front panel 10.

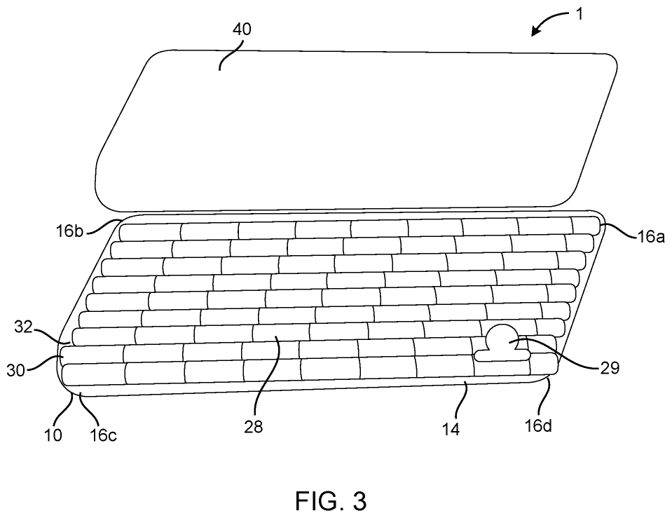

Referring to FIGS. 2 and 3, the outer section 14 includes a padding member 28. The padding member 28 is a flexible yet durable plastic foam such as EVA foam and is formed with rows 30 separated by grooves 32, and the padding member 28 is attached to the front panel 10 with an adhesive. In this embodiment, the rows 30 and grooves 32 extend longitudinally along the length of the front panel 10 but the padding member 28 could also be configured to have columns and grooves extending transversely along the width of the front panel 10. The rows 30 and grooves 32 serve to aid the vehicle body protector 1 to deform and maintain a shape corresponding to the vehicle body's contours. In addition, the padding member 28 is provided with a portion with a flat surface 29 for attaching logos via heat transfer or adhesive. Also, in this embodiment, the padding member 28 includes a top-to-bottom curvature, i.e., slightly convex at a midportion extending longitudinally along the length of the front panel 10, to conform with the shape of vehicle doors.

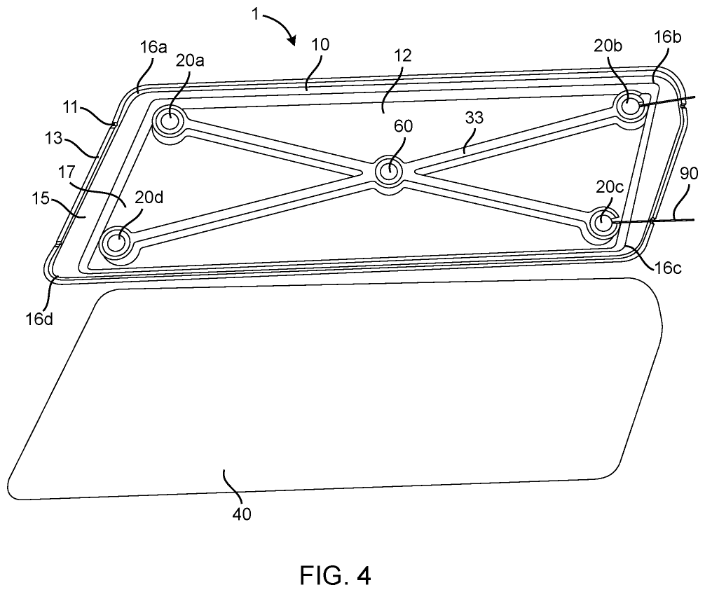

Referring to FIGS. 3 and 4, the flexible rear panel 40 is sized and shaped to fit on the inner section upper surface 15. Moreover, the thickness of the rear panel 400 is substantially similar to the height of the lip 13, i.e., the distance between the edge of the lip 13 and the upper surface 15. In this embodiment, in addition to the rear panel 40 being friction fit with the inner section lip 13, an adhesive is applied to the upper surface 15 to further secure the rear panel 40 to the upper surface 15. As the height of the receptacles 18a-e is substantially similar to the height between the distance between the lower surface 17 and the upper surface 15, when the rear panel 40 is attached to the front panel 10, the rear panel 40 is substantially flat. In this embodiment, the rear panel 40 is constructed of a flexible yet durable plastic foam such as EVA foam. The rear panel 40 serves to protect the body of the vehicle 100 from making direct contact with the components on the front panel inner section 12 to avoid potential damage to the body of the vehicle 100. However, in other embodiments, the rear panel 40 could be eliminated and the vehicle body protector 1 could be installed on the vehicle 100 with only the front panel 10.

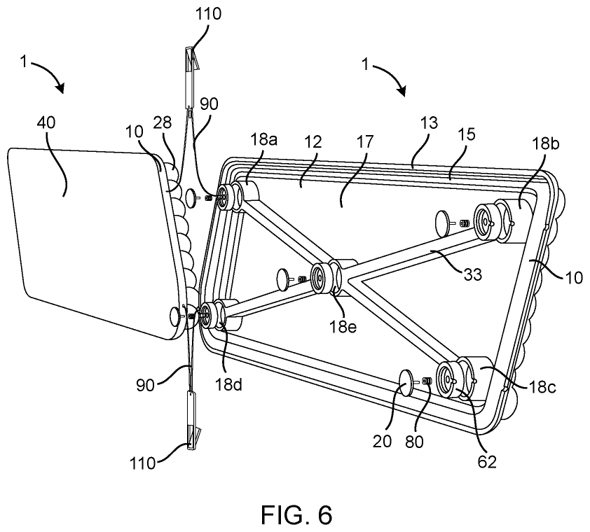

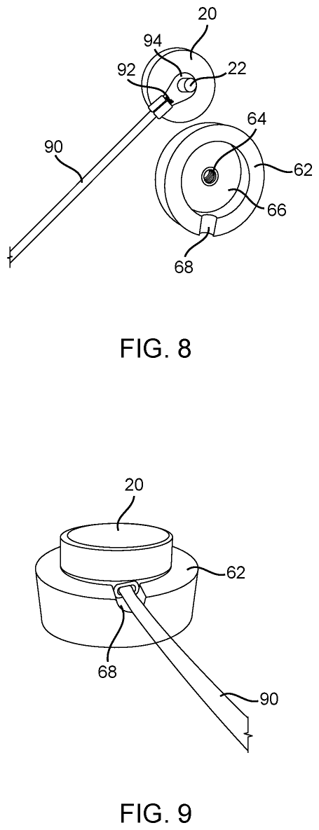

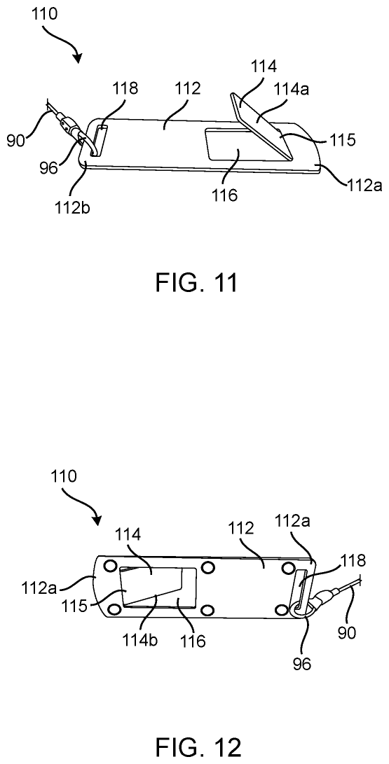

Referring to FIGS. 6-12, the vehicle body protector 1 is provided with a theft-protection device 50. In general, the theft-protection device 50 includes a magnet assembly 60, an opposing locking assembly 110 and a cable 90.

Referring to FIGS. 6-9, in this embodiment, five magnet assemblies 60 are provided to accommodate the primary magnets 20a-e. The magnet assembly 60 includes a lower member 62 having an aperture 64 at its center. Each lower member 62 is positioned in and secured to the receptacle 18a-e. Each receptable 18a-e is cylindrical and includes a lower space 19 for receiving and housing the lower member 62. Each receptable 18a-e also includes an opening 21 on a top edge for the cable 90 to pass through. The lower member 62 is also cylindrical and includes an upper space 66 for receiving and housing the primary magnet 20a-e. The lower member 62 also includes an opening 68 on a top edge for the cable 90 to pass through. As such, when installed, the receptacle opening 21, lower member opening 68 and front panel opening 11 are aligned to accommodate the cable 90. The receptacle lower space 19 is sized and shaped to receive and secure the lower member 62 in friction fit. Alternatively, or in addition to the friction fit, the lower member 62 could be fixed to the lower space 19 with an adhesive. As a further alternative, inner walls of the receptacles 18a-e and outer walls of the lower member 62 could have matching threads for a threaded engagement of the components. Also, the height of the lower space 19 is substantially similar to the height of the lower member 62 such that top surfaces of the receptacle 18a-e and lower member 62 are level. In this embodiment, the lower member 62 is constructed of a durable plastic but other materials such as metal or rubber could be used.

Still referring to FIGS. 6-9, the magnet assembly 60 also includes insert 80 having a threaded aperture 82 extending therethrough at its center for receiving the extension member 22 of the primary magnets 20a-e. The insert 80 also includes outer grooves 84 on an outer surface and is frictionally engaged and secured with the aperture 64 of the lower member 62. In this embodiment, the insert 80 is cylindrical and sized substantially similar to the lower member aperture 64 such that the insert 80 is well-secured to the lower member aperture 64. In the alternative, the outer grooves 84 of the insert 80 could be replaced with threads and the lower member aperture 64 could include matching threads so that the insert 80 and lower member 62 are secured via threaded engagement. In this embodiment, the insert 80 is constructed of a durable metal but other materials such as plastic could be used.

As shown in FIGS. 6-9, a first end of the cable 90 is provided with a metal reinforcement member 92 having an aperture 94 for securing to at least one receptacle 18a-e, preferably a corner receptacle 18a-d. In the embodiments shown, the cable 90 is a PVC coated metal wire, however, the wire could be coated with vinyl and other materials could be used, such as braided nylon and twisted polypropylene. In this embodiment, the cable 90 is secured to the two corner receptacles 18a-d but the cable 90 could also be secured to the midpoint receptacle 18e. The cable first end aperture 94 is secured to the threaded primary magnet extension members 22, which are configured to engage the insert threaded apertures 82. Then, the primary magnet extension members 22 are secured in threaded engagement with the insert threaded aperture 82 with the cable first end aperture 94 therebetween. As mentioned above, the receptacle opening 21, lower member opening 68 and front panel opening 11 are aligned, and the cable 90 is extended therethrough. In this embodiment, the rear panel 40 is installed on the upper surface 15 as described above with the cable extending between the rear panel 40 and upper surface 15. In other embodiments, however, the front panel opening 11 could be replaced with an aperture extending through the wall 23 of the front panel 10 at or near the corner receptacles 18a-d and the cable 90 could extend therethrough. As a result, the rear panel 40 could be attached to the upper surface 15 without the cable 90 therebetween.

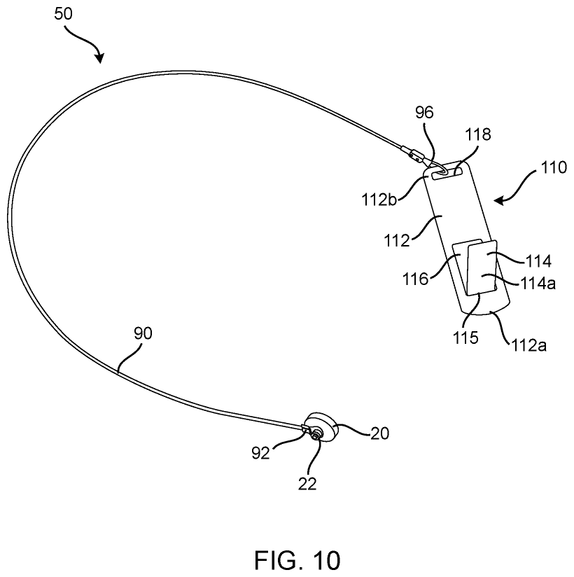

Referring now to FIGS. 10-12, the locking assembly 110 includes a body member 112 and a locking member 114 extending therefrom and integrally formed with the body member 112. In this embodiment, the body member 112 is constructed of a flexible plastic material and is generally rectangular in shape. As such, damage to the vehicle 100 is prevented when used. The locking member 114, having a top side 114a and a bottom side 114b, is formed from a rectangular partial first cutout 116 on a distal end 112a of the body member 112, resulting in the locking member 114 being hingedly coupled to the body member 112 via a hinge portion 115. On an opposing proximal end 112b, another substantially rectangular second cutout 118 is formed on the body member 112 for a second end of the cable 90 to attach to. The second end of the cable 90 is provided with a loop 96 and is secured to the second cutout 118. In the embodiments shown, for example, in FIGS. 2 and 6, a single locking assembly 110 is shared with two magnet assemblies 60 of two adjacent vehicle body protectors 1 by attached respective second ends of cables 90 to the second cutout 118. However, separate theft-protection devices 50 with separate locking assemblies 110 could be used, i.e., a total of four locking assemblies 110 instead of two as shown in FIGS. 2 and 6. Moreover, when only one vehicle body protector 1 is used, one or more theft-protection devices 50 could be utilized. As shown in the figures, two vehicle body protectors 1 are coupled together with the cables 90. However, additional vehicle body protectors 1 could be coupled together with the cables 90 as described above.

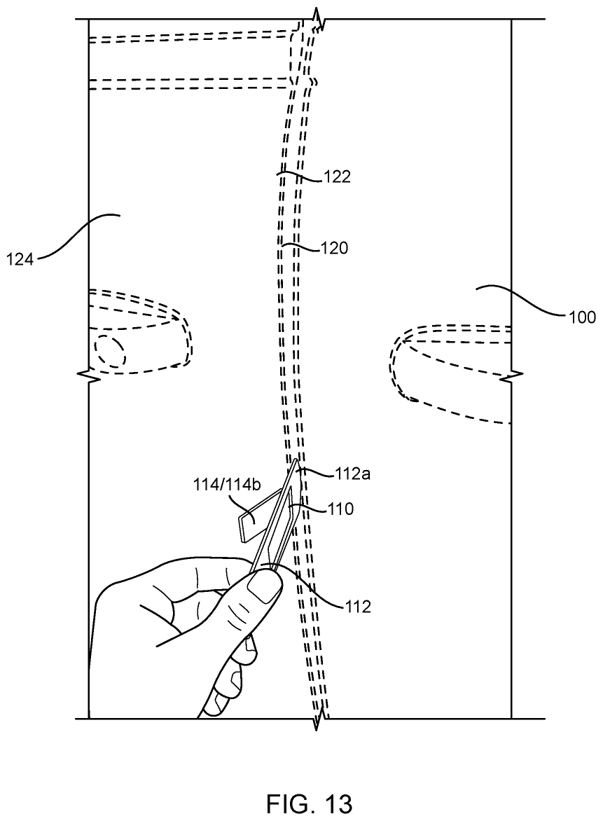

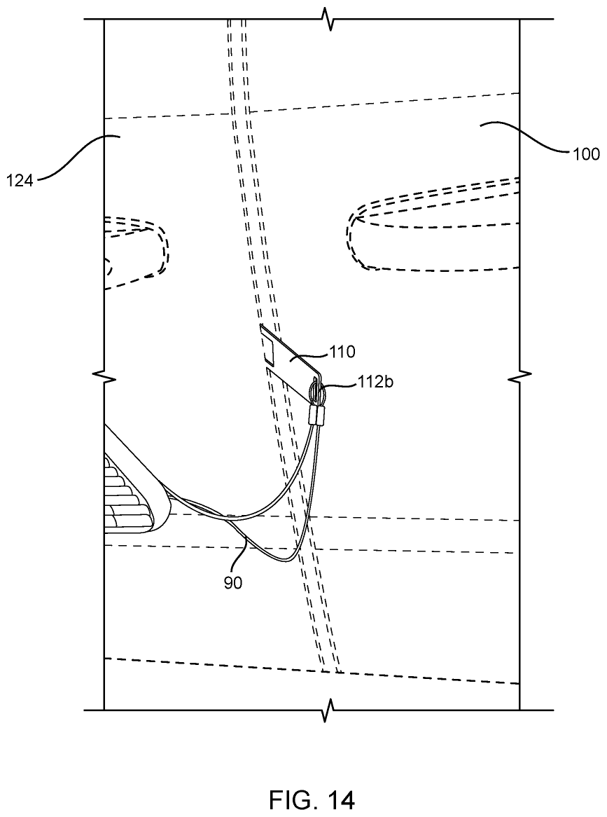

Referring now to FIGS. 1, 13 and 14, to install the vehicle protector 1 to a vehicle 100, a user first magnetically attaches the vehicle protector 1 to the vehicle 100 with the padding member 28 facing outward. The cables 90 extend from the front panel 10 with the locking assemblies 110 extending from the second end of the cables 90. As shown in FIG. 13, the user inserts the distal end 112a of the body member 112 of the locking assembly 110 into a slot 120 formed adjacent to a free edge 122 of a door 124 of the vehicle 110, i.e., the edge of the door that swings out when opened, usually the edge where the door handle is located. More specifically, the body member 112 is inserted with the extended locking member 114 facing the free edge 122 of the door 124. This step is performed with the door 124 fully closed and preferably locked. As a result, the bottom side 114b of the locking member 114 abuts an interior of the door 124 and is secured to the vehicle 100. If the body member 112 is pulled, the locking member 114 further engages the interior of the door 124 and prevents the body member 112 from releasing from the vehicle 100. This is due to the locking member 114 not being capable of flattening out even when the top side 114b makes contact with the body member 112. That is, the hinge portion 115 of the locking member 114 creates sufficient clearance to prevent the locking member 114 from exiting the slot 120. To uninstall, the user first opens the door 124 and removes the locking assembly 110. The user then engages the vehicle body protector 1 and pulls the same from the door 124 to eliminate the magnetic force between the vehicle body protector 1 and the door 124. The vehicle body protector 1 is then stored. In the embodiments shown, each vehicle body protector 1 sized to fit in a trunk of a vehicle.

In an alternative embodiment, the vehicle body protector 1 could be installed on walls of a garage or other vehicle storage facilities. The walls could include metal sheets and the vehicle body protector 1 could be magnetically attached thereto to prevent or minimize damage to the vehicle body in the event the vehicle contacts the wall. In a further alternative embodiment, the vehicle body protector 1 could be installed on the walls with adhesive.

One of ordinary skill in the art will recognize that the vehicle body protector of the present invention to take on other shapes and sizes and could also be used in a variety of applications. For example, the vehicle body protector could be used in walls inside of a house to protect infants and toddlers from injury due to contact with walls.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes, which come within the meaning and range of equivalency of the claims, are to be embraced within their scope.

1. A vehicle body protector comprising:
a flexible front panel comprising an inner section and an opposing outer section, the front panel having a plurality of corners and a midpoint positioned substantially equidistant from each corner,
the inner section comprising: a plurality of first receptacles configured to receive a plurality of first magnets, each of the first magnets having an extension member extending therefrom, each first receptacle and first magnet being substantially circular, each first magnet housed within each first receptacle and positioned at each corner and the midpoint; and a plurality of second receptacles configured to receive a plurality of second magnets, each second receptacle and second magnet being substantially elongate, each second magnet housed within each second receptacle and positioned between each corner and midpoint, and
the outer section comprising a padding member comprising a plurality of grooves;
a flexible rear panel sized and shaped substantially the same as the front panel, wherein the inner section of the front panel and the rear panel are operably coupled together by frictional engagement; and
a theft-protection device comprising a first magnet assembly, an opposing locking assembly and a cable therebetween,
the first magnet assembly comprising: a lower member comprising a first aperture, the lower member positioned in one of the plurality of first receptacles; an insert having a second aperture, the insert operably coupled to the first aperture; and a first end of the cable, the cable first end operably coupled to the extension member of one of the plurality of first magnets, wherein the extension member of one of the plurality of first magnets is operably coupled to the second aperture of the insert while the cable first end is positioned between one of the plurality of first magnets and the lower member, and
the locking assembly comprising: a body member and a locking member, the locking member being flexible and extending from the body member, wherein the locking assembly is operably coupled with a second end of the cable;
wherein the rear panel is magnetically attached to a body of a vehicle; and
wherein the locking member is inserted into a slot formed adjacent to an edge of a door of the vehicle, whereby the locking member abuts an interior of the door and is secured to the vehicle.

2. The vehicle body protector of claim 1, wherein the front panel is constructed of a flexible foam.

3. The vehicle body protector of claim 1, wherein the insert is coupled to the first aperture by threaded engagement.

4. The vehicle body protector of claim 1, wherein the extension member is coupled to the second aperture by threaded engagement.

5. The vehicle body protector of claim 1, wherein the lower member is coupled to the first receptacle by frictional engagement.

6. The vehicle body protector of claim 1, wherein the first receptacle further comprises a first opening and the lower member further comprises a second opening, wherein the first and second openings are aligned such that the cable extends therethrough.

7. A vehicle body protector comprising:
a front panel comprising an inner section and an opposing outer section, the front panel having a plurality of corners and a midpoint positioned substantially equidistant from each corner,
the inner section comprising: a plurality of first receptacles configured to receive a plurality of first magnets, each first magnet housed within each first receptacle; and
the outer section comprising a padding member; and
a theft-protection device comprising a first magnet assembly, an opposing locking assembly and a cable therebetween,
the first magnet assembly comprising: a lower member positioned in one of the plurality of first receptacles; an insert operably coupled to the lower member; and a first end of the cable, the cable first end operably coupled to one of the plurality of first magnets, wherein one of the plurality of first magnets is operably coupled to the insert while the cable first end is positioned between one of the plurality of first magnets and the lower member, and
the locking assembly comprising a locking member, the locking member being flexible, wherein the locking assembly is operably coupled with a second end of the cable;
wherein the front panel is magnetically attached to a body of a vehicle; and
wherein the locking member is inserted into a slot formed adjacent to an edge of a door of the vehicle, whereby the locking member abuts an interior of the door and is secured to the vehicle.

8. The vehicle body protector of claim 7, further comprising a rear panel sized and shaped substantially the same as the front panel, wherein the inner section of the front panel and the rear panel are operably coupled together.

9. The vehicle body protector of claim 8, wherein front panel and the rear panel are operably coupled together by frictional engagement.

10. The vehicle body protector of claim 7, wherein the inner section further comprises at least one second receptacle configured to receive at least one second magnet, the at least one second receptacle and the at least one second magnet being substantially elongate, the at least one second magnet housed within the at least one second receptacle.

11. The vehicle body protector of claim 10, wherein the at least one of second magnets is flexible.

12. The vehicle body protector of claim 7, wherein each of the plurality of first magnets comprises an extension member extending therefrom.

13. The vehicle body protector of claim 12, wherein the lower member comprises a first aperture such that the insert is operably coupled thereto.

14. The vehicle body protector of claim 13, wherein the insert comprises a second aperture such that the extension member is operably coupled thereto.

15. A vehicle body protector comprising:
a panel assembly having a first side and an opposing second side, the panel assembly comprising: a padding member on the first side; a housing on the second side; and at least one magnet positioned within the housing; and
a theft-protection device comprising: a cable having a first end and an opposing second end, the cable first end operably coupled to the panel assembly; and an opposing locking assembly, the cable second end operably coupled to the locking assembly;
wherein the panel assembly is magnetically attached to a body of a vehicle; and
wherein the locking assembly is secured to the vehicle.

16. The vehicle body protector of claim 15, wherein the theft-protection device further comprises a magnet assembly positioned within the housing, the magnet assembly comprising: a receptacle; a lower member positioned in the receptacle; and an insert operably coupled to the lower member;
wherein the magnet is operably coupled to the insert with the cable first end positioned between the magnet and the lower member.

17. The vehicle body protector of claim 16, wherein the magnet comprises an extension member extending therefrom, the lower member comprises a first aperture such that the insert is operably coupled thereto, and the insert comprises a second aperture such that the extension member is operably coupled thereto.

18. The vehicle body protector of claim 15, wherein the locking assembly further comprises a body member operably coupled to the cable second end, the locking member integrally formed with the body member, the locking member extending from the body member.

19. The vehicle body protector of claim 18, wherein the locking member is flexible.

20. The vehicle body protector of claim 19, wherein the locking member is inserted into a slot formed adjacent to an edge of a door of the vehicle, whereby the locking member abuts an interior of the door.
